(19) United States
(12) Patent Application Publication
(10) Pub. No.: US 2025/0060412 A1
(43) Pub. Date: Feb. 20, 2025

(54) ANOMALY DETECTION METHOD FOR ENERGY STORAGE SYSTEM, POWER CONTROL SYSTEM, AND TEMPERATURE PREDICTION DEVICE

(71) Applicant: DELTA ELECTRONICS, INC., Taoyuan City (TW)

(72) Inventors: Juin-Lin PAN, Taoyuan City (TW); Hao-Kai WU, Taoyuan City (TW); Bo-Jie WANG, Taoyuan City (TW)

(21) Appl. No.: 18/384,833

(22) Filed: Oct. 27, 2023

(30) Foreign Application Priority Data
Aug. 15, 2023 (CN) 202311026247.6

(51) Int. Cl. G01R 31/367; G01R 31/392; H05K 7/20

(52) U.S. Cl. CPC G01R 31/367; G01R 31/392; H05K 7/20218

(57) ABSTRACT

An anomaly detection method for an energy storage system includes receiving multiple sensing data retrieved from an electronic component of the energy storage system; inputting the multiple sensing data to a temperature prediction model; respectively receiving the multiple sensing data of same type and computing multiple time-series features related to the type based on the multiple sensing data of the type by each of a plurality of model encoders; outputting the multiple time-series features of each type to a reweighting model; computing a predicted temperature feature based on the multiple time-series features by the reweighting model and outputting the predicted temperature feature to a model decoder; reconstructing a predicted temperature feature by the model decoder to generate a predicted temperature of the electronic component; and determining whether the electronic component operates abnormally by estimating an error between the predicted temperature and a current temperature.

### BACKGROUND OF THE DISCLOSURE

### Technical Field

The disclosure generally relates to a detection method, a power-supplying system and device using the detection method, and more particularly, to an anomaly detection method for an energy storage system, a power control system, and a temperature prediction device.

### Description of Related Art

The current anomaly detection technique for power supply devices is to monitor sensing data, such as voltage, current, or temperatures, of the electronic components disposed in the power supply devices and design tolerant ranges of the sensing data. When the control system connected to the power supply devices detects that the sensing data exceeds the tolerant ranges, it immediately determines an abnormality of the power supply device and immediately shuts it down to prevent damage. In the meantime, the control system dispatches power from other power supply devices to maintain an uninterrupted power supply.

One of the techniques for monitoring the temperature of the electronic components is to monitor temperature changes in a liquid-cooling system. However, there are numerous factors that affect the temperature changes of the liquid-cooling system. For example, the temperature of the liquid-cooling system is related to the environmental condition of the liquid-cooling system and fans. As a result, the temperature changes of the liquid-cooling system cannot represent the loading amount of the power supply devices. As the temperature change of the liquid-cooling system being adopted as the factor of determining the anomaly of the power supply devices, it may result in a misjudgment.

Furthermore, the control system receives sensing data from the power supply devices, where one type of the received sensing data is high-power signals. Because the control system includes multiple modules and is bulky, the collection of the high-power signals for implementations may cause an operational risk.

In the related art, the trained artificial intelligence modules are utilized to detect the anomaly in corresponding fields. Nevertheless, there are problems existing due to the above stated reasons, such as inaccurate trained artificial intelligence models and unsafe implementations. In sum, improvements for the current anomaly detection techniques are required.

### SUMMARY OF THE DISCLOSURE

The disclosure provides an anomaly detection method for an energy storage system, a power control system, and a temperature prediction device.

One of the exemplary embodiments of the present disclosure is to provide an anomaly detection method for an energy storage system including (a) receiving a plurality of sensing data retrieved from an electronic component of the energy storage system, where each of the plurality of sensing data is respectively related to one type: (b) respectively inputting the plurality of sensing data to a temperature prediction model according to the type of each of the plurality of sensing data, where the temperature prediction model includes a plurality of model encoders, a reweighting model, and a model decoder: (c) receiving, by each of the plurality of model encoders, the plurality of sensing data of same type and respectively computing a plurality of time-series features related to the type based on the plurality of sensing data of each type: (d) outputting the plurality of time-series features of each type to the reweighting model; (e) computing, by the reweighting model, a predicted temperature feature by using the plurality of time-series features and outputting the predicted temperature feature to the model decoder; (f) reconstructing, by the model decoder, the predicted temperature feature to generate a predicted temperature of the electronic component; and (g) determining whether the electronic component operates abnormally by estimating an error between the predicted temperature and a current temperature.

One of the exemplary embodiments of the present disclosure is to provide a power control system including a sensor module, a storage medium, and a computation device. The sensor module is configured to retrieve a plurality of sensing data of an electronic component, where each of the plurality of sensing data is respectively related to one type. The storage medium is connected to the sensor module and configured to store a temperature prediction model. The temperature prediction model includes a plurality of model encoders, a reweighting model, and a model decoder. The plurality of model encoders is configured to receive the plurality of sensing data. The reweighting model is connected to the plurality of model encoders. The model decoder is connected to the reweighting model. The computation device is connected to the sensor module and the storage medium and configured to perform operations by using the temperature prediction model including receiving, by each of the plurality of model encoders, the plurality of sensing data of same type and respectively computing a plurality of time-series features related to the type by using the plurality of sensing data of same type; outputting the plurality of time-series features of each type to the reweighting model; computing, by the reweighting model, a predicted temperature feature based on the plurality of time-series features and outputting the predicted temperature feature to the model decoder; reconstructing, by the model decoder, the predicted temperature feature to generate a predicted temperature of the electronic component; and determining whether the electronic component operates abnormally by estimating an error between the predicted temperature and a current temperature.

One of the exemplary embodiments of the present disclosure is to provide a temperature prediction device including a storage medium and a processor. The storage medium is configured to store program codes. The processor is connected to the storage medium and configured to load the program codes to perform operations including receiving a plurality of sensing data retrieved from an electronic component of an energy storage system, where each of the plurality of sensing data is respectively related to one type: respectively inputting the plurality of sensing data to a temperature prediction model according to the type of each of the plurality of sensing data, where the temperature prediction model includes a plurality of model encoders, a reweighting model, and a model decoder: receiving, by each of the plurality of model encoders, the plurality of sensing data of same type and respectively computing a plurality of time-series features related to the type based on the plurality of sensing data of same type: outputting the plurality of time-series features of each type to the reweighting model: computing, by the reweighting model, a predicted temperature feature by using the plurality of time-series features and outputting the predicted temperature feature to the model decoder; and reconstructing, by the model decoder, the predicted temperature feature to generate a predicted temperature of the electronic component.

The technical solution provided by the present disclosure improves the accuracy of predicting the temperature, and the problem that the entire system crashes due to some electronic components being damaged is solved, therefore, the technical effects that the entire system being stable and the power supply remaining uninterrupted may be achieved.

### BRIEF DESCRIPTION OF THE DRAWINGS

FIG. 1 is a block diagram illustrating an energy storage system according to an embodiment of the present disclosure.

FIG. 2 is a block diagram illustrating a power control system according to an embodiment of the present disclosure.

FIG. 3 is a flowchart illustrating an anomaly detection method for the energy storage system according to an embodiment of the present disclosure.

FIG. 4 illustrates a workflow diagram of a temperature prediction model according to an embodiment of the present disclosure.

FIG. 5 illustrates a workflow diagram of a reweighting model according to an embodiment of the present disclosure.

FIG. 6 is a block diagram illustrating a temperature prediction device according to an embodiment of the present disclosure.

FIG. 7 is a flowchart illustrating a temperature prediction method according to an embodiment of the present disclosure.

FIG. 8a and FIG. 8b are workflow diagrams of training autoencoders according to an embodiment of the present disclosure.

FIG. 9 is a flowchart of training a model encoder according to an embodiment of the present disclosure.

FIG. 10 is a flowchart of training the reweighting model according to an embodiment of the present disclosure.

FIG. 11 is a flowchart illustrating the anomaly detection method by using a predicted temperature according to an embodiment of the present disclosure.

FIG. 12 is a flowchart illustrating a data preprocessing procedure of training the temperature prediction model according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

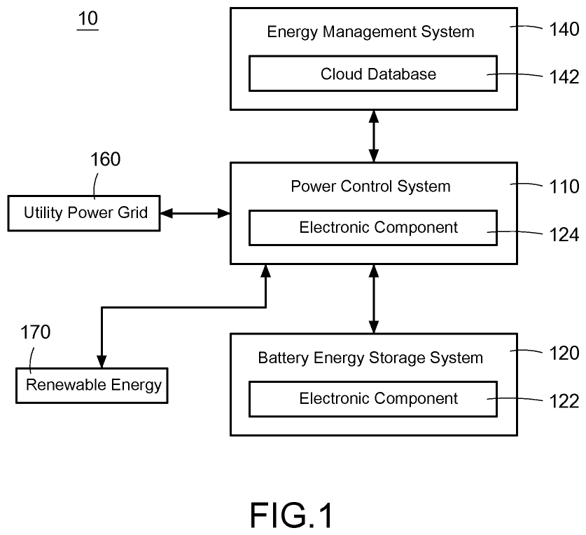

FIG. 1 is a block diagram illustrating an energy storage system according to an embodiment of the present disclosure. As shown in FIG. 1, the energy storage system 10 includes a power control system 110, a battery energy storage system 120, and an energy management system 140.

The power control system 110 is connected to the battery energy storage system 120 and the energy management system 140. The power control system 110 receives electric power produced by a renewable energy 170 and instantly provides electric power to nearby electronic devices. When the amount of electric power produced by the renewable energy 170 is greater than nearby electricity consumption, the power control system 110 stores the redundant electric power to the battery energy storage system 120. The battery energy storage system 120 may provide electric power being stored when electricity production of the renewable energy 170 cannot satisfy the nearby electronic devices that require instant electric power. When the battery capacities of the battery energy storage system 120 are full, the power control system 110 provides the electric power produced by the renewable energy 170 to a utility power grid 160.

The energy management system 140 includes a cloud database 142. The cloud database 142 is configured to store a relational database, a time-series database, and a model database (not shown in figures).

The energy management system 140 is a central control system that monitors and manages the system status. In an embodiment, the energy management system 140 performs a data filtering process, a data preprocessing process, a training and usage of the processes of deep-learning model architecture, a system status diagnosis, a trend analysis of data curve, an anomaly notification, and a model management. Furthermore, the energy management system 140 may also provide a graphical user interface to display the frontend status.

Accordingly, the energy storage system 10 not only independently provides electric power within a local area as a microgrid but also operates with the utility power grid 160 in parallel.

In an embodiment, an electronic component 122 is disposed in the battery energy storage system 120 and configured to control charging and discharging power, regulate heat dissipation, and manage power values. For example, the electronic component 122 may be a power module, a liquid-cooling component, or a component of an electric power system. For the sake of brevity, the electronic component 122 represents any of the components listed above.

In an embodiment, an electronic component 124 is disposed in the power control system 110 and configured to be an electric power switch. For example, the electronic component 124 may be an insulated gate bipolar transistor (IGBT), as a switch or a regulator of direct current, alternating current, and voltage.

In an embodiment, the electronic component 124 may be also the component of controlling charging and discharging power, regulating heat dissipation, and managing power values, as described above.

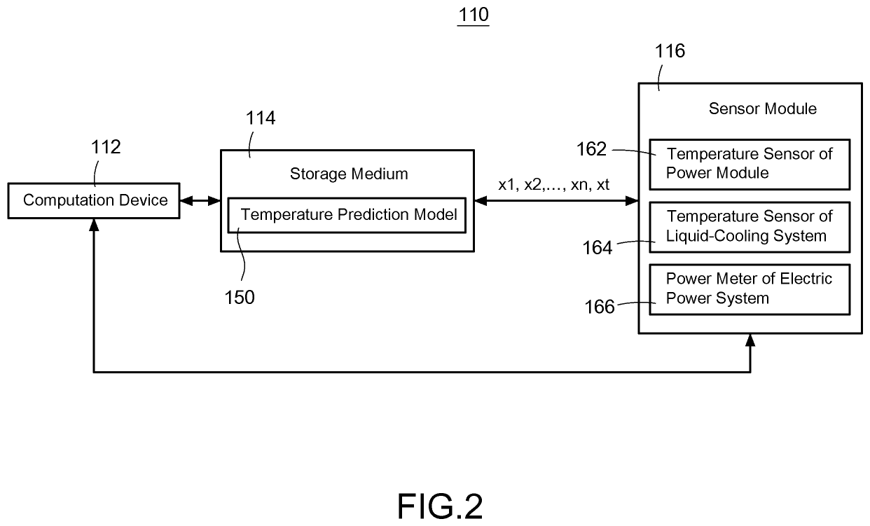

FIG. 2 is a block diagram illustrating a power control system according to an embodiment of the present disclosure. As shown in FIG. 2, the power control system 110 includes a computation device 112, a storage medium 114, and a sensor module 116. The storage medium 114 is connected to the computation device 112 and the sensor module 116.

In an embodiment, the sensor module 116 is configured to retrieve data generated by the electronic components 122 and 124 (shown in FIG. 1) to generate a plurality of sensing data where each sensing data is related to a type. For example, the sensing data may include the data respectively retrieved from multiple electronic components 122 of different types.

In an embodiment, the sensor module 116 includes a temperature sensor 162 of the power module, a temperature sensor 164 of a liquid-cooling system, and a power meter 166 of the electric power system. The sensing data include a power module temperature (such as a chamber temperature), a liquid-cooling system temperature (such as a liquid temperature of the liquid-cooling system), and the electric power system value (such as direct current, alternating current, voltage, and a maximal difference of three-phase electrical power). In the embodiment, the sensing data include the direct current, the alternating current, the voltage, and the maximal difference of the three-phase electrical power, that is, the sensor module 116 retrieves the sensing data of six types. It should be noted that it is not limited to any specific type of sensing data, and the sensing data related to the power control system 110 and the battery energy storage system 120 that may be collected and analyzed for interpreting the system status are utilized in the present disclosure.

In an embodiment, the sensing data x1 is related to a first type, the sensing data x2 is related to a second type, the sensing data xn is related to an N^{th} type, and the sensing data xt is related to a T^{th} type. In an embodiment, the sensing data xt is the power module temperature.

In an embodiment, the storage medium 114 is configured to store the plurality of sensing data and a temperature prediction model 150.

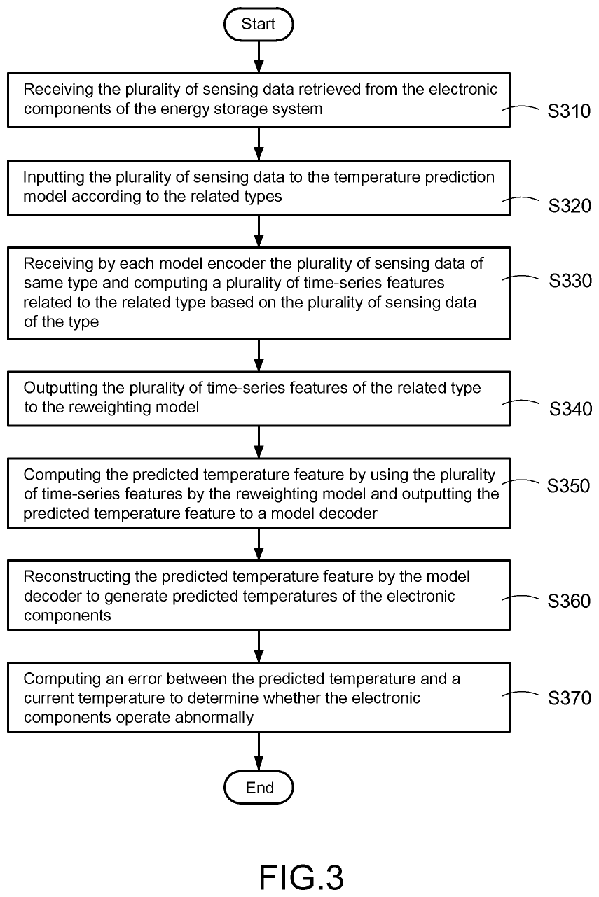

In an embodiment, the computation device 112 is configured to perform the anomaly detection method by obtaining and using a predicted temperature. For facilitating the understanding of the anomaly detection method, the following description is provided with reference to FIG. 3.

FIG. 3 is a flowchart illustrating the anomaly detection method for the energy storage system according to an embodiment of the present disclosure. The anomaly detection method may be implemented by the energy storage system 10 of FIG. 1 and the power control system 110 of FIG. 2.

In step S310, the plurality of sensing data retrieved from the electronic components 122 and 124 of the energy storage system 10 are received.

In step S320, the plurality of sensing data is respectively inputted to the temperature prediction model 150 according to the types of the plurality of sensing data.

In step S330, each model encoder respectively receives the plurality of sensing data of same type and computes a plurality of time-series features related to the type based on the plurality of sensing data of the type.

In step S340, the plurality of time-series features of the type are outputted to a reweighting model.

In step S350, a predicted temperature feature is computed based on the plurality of time-series features by the reweighting model and the predicted temperature feature is outputted to a model decoder.

In step S360, the predicted temperature feature is reconstructed by the model decoder to generate predicted temperatures of the electronic components 122 and 124.

In step S370, an error between the predicted temperature and a current temperature of the electronic component 122/124 is computed to determine whether the electronic component 122/124 operates abnormally.

In step S310, the energy storage system 10 receives the sensing data of the electronic components 122 and 124 retrieved by the sensor module 116 of the power control system 110. Each sensing data respectively relates to one type. In an embodiment, the sensing data is related to a time curve of one type. For example, the sensing data x1 is the time curve of the chamber temperature; the sensing data x2 is the time curve of the liquid temperature of the liquid-cooling system: the sensing data xn is the time curve of the alternating current; the power module temperature xt is the time curve of the temperature.

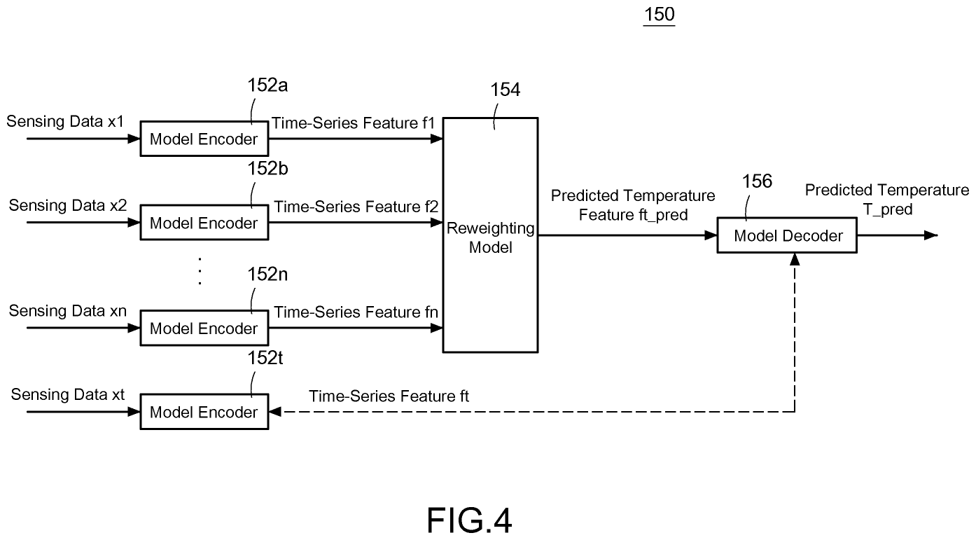

In step S320, the computation device 112 loads the temperature prediction model 150, where the temperature prediction model 150 includes the plurality of model encoders, the reweighting model, and the model decoder. For facilitating the understanding of the temperature prediction model 150, the following description is provided with reference to FIG. 4

FIG. 4 illustrates a workflow diagram of the temperature prediction model according to an embodiment of the present disclosure. As shown in FIG. 4, the temperature prediction model 150 includes the model encoders 152a, 152b, . . . , 152n, and 152t, the reweighting model 154, and the model decoder 156.

In an embodiment, the quantity of the model encoders 152a to 152t corresponds to the quantity of the types. In other words, each type respectively has a corresponding model encoder.

In an embodiment, the sensing data x1 related to the first type is inputted to the model encoder 152a: the sensing data x2 related to the second type is inputted to the model encoder 152b; and the sensing data xn related to the N^{th} type is inputted to the model encoder 152n. For example, the sensing data processed by the model encoder 152a is the time curve of the chamber temperature: the sensing data processed by the model encoder 152b is the time curve of the liquid temperature of the liquid-cooling system: the sensing data processed by the model encoder 152n is the time curve of the alternating current: the sensing data processed by the model encoder 152t is the time curve of the power module temperature xt.

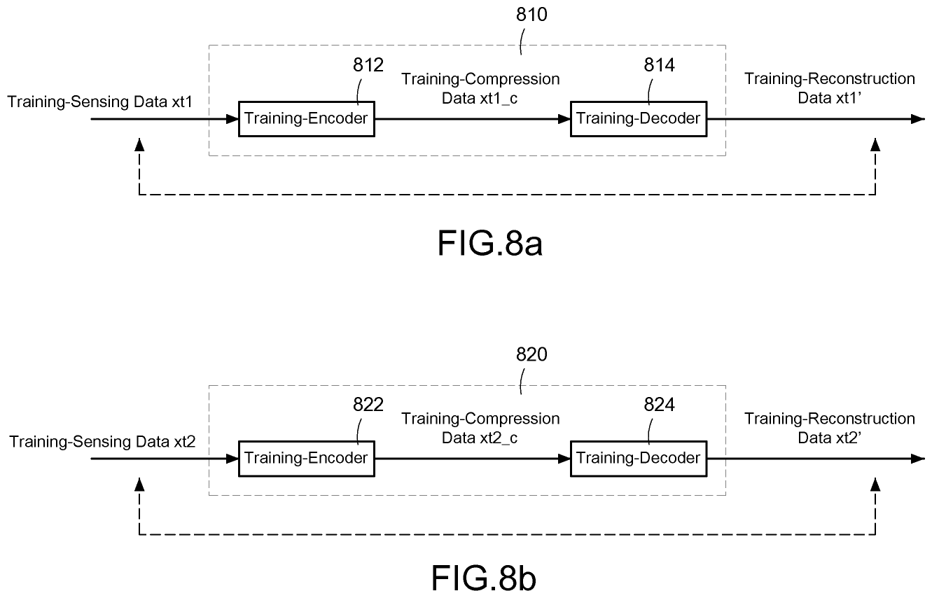

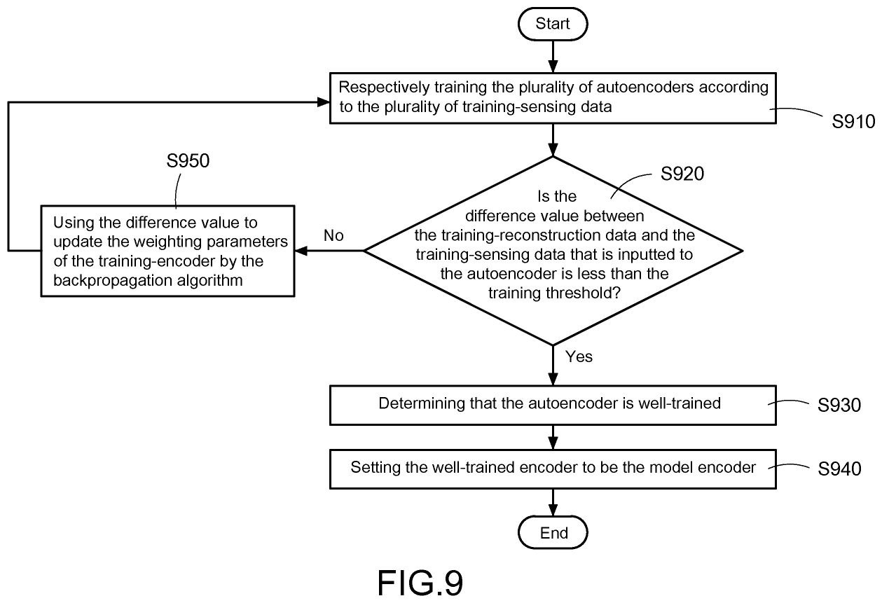

In an embodiment, the model encoders 152a, 152b, . . . , 152n, and 152t are encoders of pre-trained autoencoders, such as those trained by using a Fourier transform, a wavelet transform, a time-frequency transform, or a statistical feature computing. The model encoders 152a, 152b, . . . , 152n, and 152t are used as feature-retrieving models of the time-series data for retrieving the time-series features of the sensing data. The training method of the model encoders is provided in the following description with reference to FIGS. 8a, 8b, and 9.

Reference is made back to FIG. 3. In step S330, the model encoders 152a, 152b, . . . , 152n, and 152t respectively process the sensing data of its type and correspondingly compute the time-series features f1, f2, . . . , fn, and ft of each type according to the sensing data of each type.

In an embodiment, the model encoder 152a processes the time curve of the chamber temperature to analyze the time-series feature f1 of the chamber temperature; the model encoder 152b processes the time curve of the liquid temperature of the liquid-cooling system to analyze the time-series features f2 of the temperature difference, and so forth. The model encoders 152a, 152b, . . . , 152n, and 152t of the temperature prediction model 150 respectively compute the time-series features f1, f2, . . . , fn, and ft related to each type.

In steps S340 and S350, the model encoders 152a, 152b, . . . , and 152n output the plurality of time-series features f1, f2, . . . , fn, and ft related to each type to the reweighting model 154. The reweighting model 154 computes the predicted temperature feature ft_pred by using the plurality of time-series features f1, f2, . . . , fn, and ft and outputs the predicted temperature feature ft_pred to the model decoder 156.

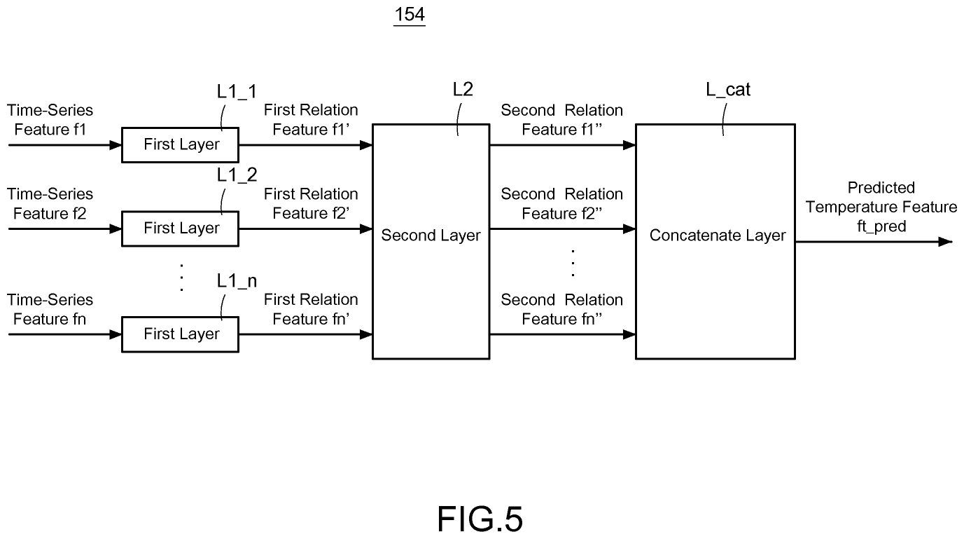

In an embodiment, the reweighting model 154 computes the relationship among the received time-series features f1, f2, . . . , fn, and ft and computes the temperature feature related to the time feature by using the time-series features f1, f2, . . . , fn, and ft to generate the predicted temperature feature ft_pred. The reweighting model 154 is described with reference to FIG. 5.

The reweighting model 154 outputs the predicted temperature feature ft_pred to the model decoder 156, and the model decoder 156 transforms (reconstructs) the predicted temperature feature ft_pred to be the predicted temperature.

In step S360, the model decoder 156 reconstructs the predicted temperature feature ft_pred to be the predicted temperature T_pred.

In the embodiment, the model decoder 156 is formed by the decoder of the autoencoder. The model decoder 156 transforms the predicted temperature feature ft_pred to the time-domain data to generate the predicted temperature T_pred.

In an embodiment, the model encoder 152t computes the time-series feature ft according to the power module temperature xt and outputs the time-series feature ft to the model decoder 156. The model decoder 156 reconstructs the predicted temperature feature ft_pred by referring to the time-series feature ft. In the embodiment, the model decoder 156 refers to the time-series feature ft related to the power module temperature xt while reconstructing the predicted temperature T_pred, so it confirms that the reconstructed predicted temperature T_pred is highly related to the feature of the power module temperature xt to increase the accuracy of the predicted temperature T_pred.

In step S370, the computation device 112 receives the current temperature, computes the error between the predicted temperature T_pred and the current temperature, and determines whether the electronic components 122 and 124 operate abnormally according to the error. In the embodiment, the energy storage system 10 focuses on the temperature variance of the electronic component, and the current temperature indicates the currently measured temperature of the electronic component, such as the power module.

The predicted temperature T_pred is deemed as the predicted temperature after the electronic component works for a while, so the predicted temperature T_pred is used as a temperature indicator of the electronic component normally working.

In an embodiment, when the error between the predicted temperature T_pred and the current temperature is greater than a threshold, the computation device 112 adds an abnormal count. In a detection period, when the abnormal count is accumulated to be greater than a tolerance value, the computation device 112 determines that the electronic component (such as the power module) works abnormally. On the contrary, the computation device 112 determines that the electronic component (such as the power module) works normally when the abnormal count is less than or equal to the tolerance value.

In an embodiment, when determining that the electronic component works abnormally, the computation device 112 issues an abnormal warning to a supervisory system, such as the energy management system 140 of FIG. 1.

The reweighting model 154 mentioned in step S340 and step S350 is further described with reference to FIG. 5.

FIG. 5 illustrates a workflow diagram of the reweighting model according to an embodiment of the present disclosure. As shown in FIG. 5, the reweighting model 154 includes a plurality of first layers L1_1, L1_2, . . . , and L1_n, a second layer L2, and a concatenate layer L_cat.

In an embodiment, the first layers are computation models, such as models utilizing a convolution computation, a linear computation, a Super Vector Machine (SVM) (or called Support Vector Regression (SVR)), a K-means computation, a Long short-term memory (LSTM), a self-attention computation, or any combination of above computation models.

The first layer L1_1 is taken as an example. The time-series feature f1 of the sensing data x1 is inputted to the computation model of the first layer L1_1. The computation model of the first layer L1_1 performs the model computation to the time-series feature f1 to generate the first relation feature f1′ of the sensing data x1. Similarly, the computation model of the first layer L1_2 performs the model computation to the time-series feature f2 to generate the first relation feature f2′ of the sensing data x2. The computation model of the first layer L1_n performs the model computation to the time-series feature fn to generate the first relation feature fn′ of the sensing data xn.

In an embodiment, the first relation features f1′, f2, . . . , and fn are inputted to the computation model of the second layer L2.

In an embodiment, the second layer L2 is a computation model, such as a model utilizing a linear computation, an attention computation, a graph neural networks computation, or any combination of the above computation models.

The computation model of the second layer L2 receives the first relation features f1′, f2′, . . . , and fn′ and respectively computes a relationship between each feature and other features to generate a plurality of second relation features. For example, the second layer L2 respectively computes the relationship between the first relation feature f1′ and other first relation features, i.e., the first relation features f2′, . . . , fn′, to generate the second relation feature f1″: the second layer L2 computes the relationship between the first relation feature f2″ and other first relation features, i.e., the first relation features f1′, f3′, . . . , and fn′ to generate the second relation feature f2″, and so forth. The second relation feature f1″ represents the relationship between the first relation feature f1′ and other first relation features f2′, . . . , and fn′. Similarly, the second relation feature f2″ represents the relationship between the first relation feature f2′ and other first relation features f1′, f3″, . . . , and fn′. The second relation feature fn″ represents the relationship between the first relation feature fn′ and other first relation features f1′, . . . , and fn−1′.

In an embodiment, the concatenate layer L_cat receives the plurality of second relation features f1″, f2″, . . . , and fn″ from the second layer L2. The concatenate layer L_cat computes the predicted temperature feature ft_pred by using the second relation features f1″, f2″, . . . , and fn″.

In an embodiment, the concatenate layer L_cat is a computation model utilizing a linear computation to combine the plurality of second relation features f1″, f2″, . . . , and fn″ into an entirety and obtains the predicted temperature feature ft_pred. The predicted temperature feature ft_pred is provided to the model encoder 156 (FIG. 4), so the model encoder 156 reconstructs the predicted temperature T_pred. The predicted temperature T_pred is described above and not repeated here for brevity.

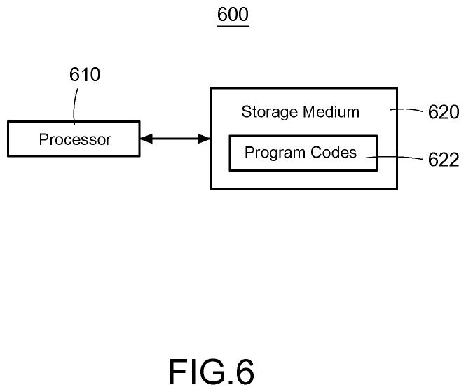

FIG. 6 is a block diagram illustrating a temperature prediction device according to an embodiment of the present disclosure. The temperature prediction device 600 includes a processor 610 and a storage medium 620. The processor 610 is connected to the storage medium 620. The storage medium 620 is configured to store a plurality of program codes 622.

In one embodiment, the processor 610 may be but not limited to a Digital Signal Processor (DSP), an Application Specific Integrated Circuit (ASIC), a Central Processing Unit (CPU), a System on Chip (SoC), a Field Programmable Gate Array (FPGA), a Network Processor IC, or the combination of the components above.

In one embodiment, the storage medium 620 may be but not limited to a Random Access Memory (RAM), a flash memory, a Read-Only Memory (ROM), a Hard Disk Drive (HDD), a Solid-State Drive (SSD), an Optical Storage, or the combination of the components above.

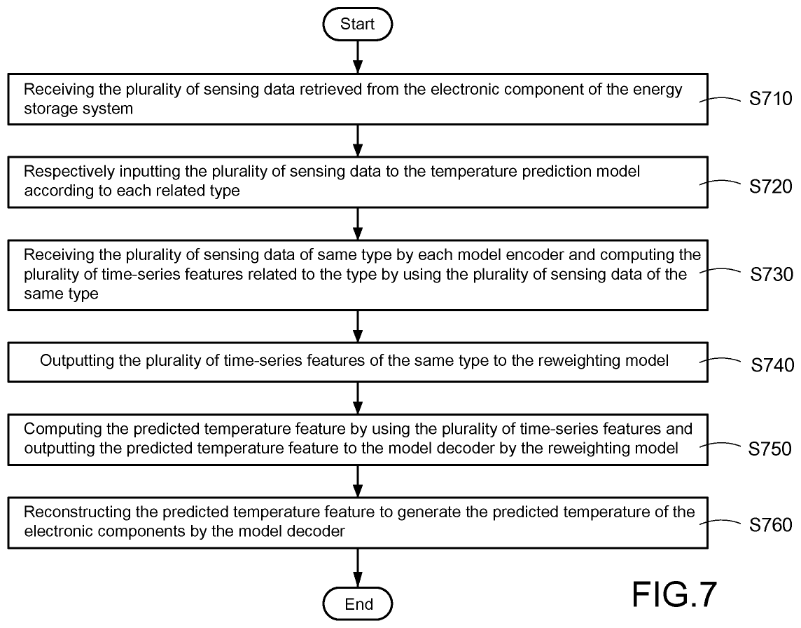

For further description of operations of the temperature prediction device 600, reference is made to FIG. 7. FIG. 7 is a flowchart illustrating the temperature prediction method according to an embodiment of the present disclosure.

In an embodiment, the temperature prediction device 600 is commutatively or electrically connected to the energy storage system (such as the energy storage system 10 shown in FIG. 1 but not shown in FIG. 6) and configured to receive the plurality of sensing data of multiple electronic components of the energy storage system 10 where each of the electronic components respectively relates to different types. The processor 610 is configured to load the plurality of program codes 622 to perform operations and compute the predicted temperature T_pred by using the plurality of sensing data related to the different types.

In step S710, the processor 610 receives the plurality of sensing data retrieved from the electronic component of the energy storage system. The plurality of sensing data is related to multiple types of the electronic component.

In step S720, the processor 610 respectively inputs the plurality of sensing data to the temperature prediction model 150 according to each related type, where the temperature prediction model 150 includes the plurality of model encoders, the reweighting model, and the model decoder.

In step S730, each model encoder receives the plurality of sensing data of same type and computes the plurality of time-series features related to the type by using the plurality of sensing data of the same type.

In step S740, each model encoder outputs the plurality of time-series features of the same type to the reweighting model 154.

In step S750, the reweighting model 154 computes the predicted temperature feature ft_pred by using the plurality of time-series features f1, f2, . . . , and fn and outputs the predicted temperature feature ft_pred to the model decoder 156.

In step S760, the model decoder 156 reconstructs the predicted temperature feature ft_pred to generate the predicted temperature T_pred of the electronic component.

Steps S710 to S760 are similar to steps S310 to S360 of FIG. 3 and the description refers to those about the temperature prediction model 150 of FIG. 4 and the reweighting model 154 of FIG. 5 which are not repeated herein for brevity.

For further description of training the plurality of model encoders 150a to 152t of the temperature prediction model 150, please refer to FIG. 8a and FIG. 8b.

FIG. 8a and FIG. 8b are workflow diagrams of training autoencoders according to an embodiment of the present disclosure. Training the autoencoder may be implemented by the computation device 112 of FIG. 2 or the temperature prediction device 600 of FIG. 6 before the abnormal detection or the temperature detection is performed. For the sake of brevity, the following description takes the computation device 112 as an example of training the autoencoder.

In an embodiment, as shown in FIG. 8a, a training-autoencoder 810 includes a training-encoder 812 and a training-decoder 814.

In an embodiment, the training-autoencoder 810 trains its computation model by using training-sensing data xt1 that belongs to one type. For example, the training-sensing data xt1 is the time curve of the chamber temperature.

The training-encoder 812 receives the training-sensing data xt1 to compute a training-compression data xt1_c and transmits the training-compression data xt1_c to the training-decoder 814. The training-decoder 814 uses the training-compression data xt1_c to generate a training-reconstruction data xt1′. In the embodiment, the computation device 112 performs a compression based on the training-sensing data xt1 and then performs a reconstruction to obtain the training-reconstruction data xt1′, so the training-reconstruction data xt1′ approximates the training-sensing data xt1. The computation device 112 compares the training-reconstruction data xt1′ with the training-sensing data xt1 to compute an error between the training-reconstruction data xt1′ and the training-sensing data xt1 and updates weighting parameters of the training-encoder 812 by a backpropagation algorithm. The training-autoencoder 810 stops training when the error between the training-reconstruction data xt1′ and the training-sensing data xt1 is less than a training threshold, and a training process of the training-autoencoder 810 is completed. At the moment the training process is completed, the training-autoencoder 810 that processes the time curve of the chamber temperature is well-trained.

Under a similar description, in an embodiment shown in FIG. 8b, the training autoencoder 820 includes a training-encoder 822 and a training-decoder 824.

In an embodiment, the training autoencoder 820 trains its computation model by using a training-sensing data xt2 that belongs to another type. For example, the training-sensing data xt2 is the time curve of the liquid temperature of the liquid-cooling system.

The training-encoder 822 receives the training-sensing data xt2 to compute a training-compression data xt2_c and transmits the training-compression data xt2_c to the training-decoder 824. The training-decoder 824 uses the training-compression data xt2_c to generate a training-reconstruction data xt2′. In the embodiment, the computation device 112 performs the compression based on the training-sensing data xt2 and then performs the reconstruction to obtain the training-reconstruction data xt2′, so the training-reconstruction data xt2′ approximates the training-sensing data xt2. The computation device 112 compares the training-reconstruction data xt2′ with the training-sensing data xt2 to compute the error between the training-reconstruction data xt2′ and the training-sensing data xt2 and updates the weighting parameters of the training-encoder 822 by the backpropagation algorithm. The training autoencoder 820 stops training when the error between the training-reconstruction data xt2′ and the training-sensing data xt2 is less than the training threshold, and the training process of the training-autoencoder 820 is completed. At the moment the training process is completed, the training-autoencoder 820 that processes the time curve of the liquid temperature of the liquid-cooling system is well-trained.

By analogy with the description above, the computation device 112 trains the quantity of the autoencoders based on a required quantity of the types.

It should be noted that the training-sensing data xt1 and xt2 may be the sensing data received from the sensor module 116 of FIG. 2 or from the cloud database 142 of FIG. 1. The training-sensing data may be the sensing data instantly received or historical sensing data.

FIG. 9 is a flowchart of training the model encoder according to an embodiment of the present disclosure. The training process of the model encoder may be performed by the computation device 112 of FIG. 2 or the temperature prediction device 600 of FIG. 6 before the abnormal detection or the temperature detection is performed. For the sake of brevity, the following description takes the computation device 112 as an example of training the autoencoder.

In step S910, the computation device 112 respectively trains each of the plurality of autoencoders according to the plurality of training-sensing data.

In step S920, the computation device 112 determines whether the difference value (error) between the training-reconstruction data and the training-sensing data that is inputted to the autoencoder is less than the training threshold. If the difference value is less than the training threshold, the process goes to step S930. If the difference value is greater than or equal to the training threshold, the process goes to step S950.

In step S930, the computation device 112 determines that the autoencoder is well-trained.

In step S940, the computation device 112 sets the well-trained encoder (training-encoder) to be the model encoder (the autoencoder includes the encoder and the decoder: the autoencoder is well-trained, so the encoder is also well-trained).

In step S950, the computation device 112 uses the difference value to update the weighting parameters of the training-encoder by the backpropagation algorithm. After step S950, the computation device 112 performs step S910 again until the autoencoder is well-trained.

Steps S910 to S930 and S950 are described as those made in FIG. 8a and FIG. 8b and not repeated for brevity.

In step S940, the computation device 112 copies the well-trained model architecture and the well-trained weighting parameters to one of the model encoders 152a to 152n of the temperature prediction model 150. For example, the training-encoder 812 of the training-autoencoder 810 that is well-trained of FIG. 8a is coped to the model encoder 152a of FIG. 4. The training-encoder 822 of the training autoencoder 820 that is well-trained of FIG. 8b is copied to the model encoder 152b of FIG. 4.

Therefore, each model encoder of the temperature prediction model 150 has the computation model that may precisely retrieve the time-series features of the sensing data related to the corresponding type.

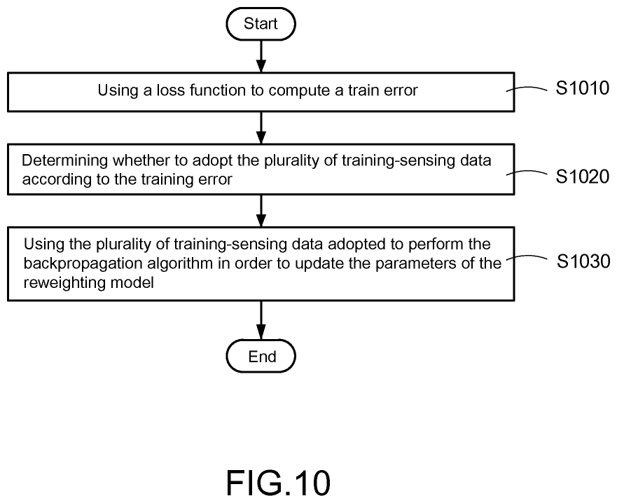

FIG. 10 is a flowchart of training the reweighting model according to an embodiment of the present disclosure. The training method of the reweighting model 154 may be performed by the computation device 112 of FIG. 2 or the temperature prediction device 600 of FIG. 6. For the sake of brevity, the following description takes the computation device 112 as an example of training the reweighting model 154.

In step S1010, the computation device 112 uses a loss function to compute a training error.

In step S1020, the computation device 112 determines whether to adopt the plurality of training-sensing data according to the training error.

In step S1030, the computation device 112 uses the plurality of training-sensing data adopted to perform the backpropagation algorithm in order to update the parameters (e.g., weightings) of the reweighting model 154.

In step S1010, the computation device 112 uses the loss function to compute a gradient descent computation for updating the parameters of the reweighting model 154.

In an embodiment, the loss function may be one or a combination of following function (1) to function (4).

$${loss}_{features , i} = {( {f}_{t , super} - {f}_{t} )}^{2} \qquad function ( 1 )$$

In function (1), loss_{feature,i} is the error of the feature domain of the i^{th} training-sensing data, fₜ is the time-series features generated by the model encoder, f_{t,super} is the maximal time-series feature of all time-series features. Function (1) is utilized to compute the difference between two temperature features.

In one embodiment, the time-series feature retrieved from the training-sensing data may be the features related to the electronic system. In this case, function (1) computes the feature difference between two flows of electric voltage or electric current.

$${loss}_{reconst , i} = {( {T}_{pred} - \hat{T} )}^{2} \qquad function ( 2 )$$

In function (2), loss_{reconst,i} is the error between the temperature feature recovered by the reweighting model 154 by using the i^{th} training-sensing data and the temperature feature of the training-sensing data, T_{pred} is the predicted temperature reconstructed by the model decoder 156, \hat{T} is the actual temperature of the training-sensing data. Function (2) is utilized to compute the difference between the temperature that is recovered and the actual temperature.

$${loss}_{cos , i} = ( 0.5 - 0.5 \times \frac{{T}_{pred} \cdot \hat{T}}{\vert {T}_{pred} \vert \vert \hat{T} \vert} ) \qquad function ( 3 )$$

Function (3) is utilized to compute the difference between a temperature feature curve of the temperature that is recovered and a temperature feature curve of the actual temperature.

$${loss}_{dis , i} = \vert discriminator ( {T}_{pred} ) - 0 \vert \qquad function ( 4 )$$

In function (4), discriminator is the discriminator for determining whether the input data is real or fake. Function (4) is utilized to determine whether the predicted temperature T_pred that is reconstructed based on the plurality of time-series features is different from the actual temperature of the sensing data inputted.

$${loss}_{i} = {loss}_{feature , i} + {loss}_{reconst , i} + {loss}_{cos , i} + {loss}_{dis , i} \qquad function ( 5 )$$

Function (5) is a linear combination of function (1) to function (4).

In an embodiment, the computation device 112 performs the backpropagation algorithm by function (6) to function (9) to update the parameter of the reweighting model 154.

$${loss}_{batch} = {\sum }_{i = 0}^{batch} {loss}_{i} \cdot ( {loss}_{i} < μ + 2 σ ) \qquad function ( 6 )$$

$$μ = \frac{1}{batch} {\sum }_{i = 0}^{batch} {loss}_{i} \qquad function ( 7 )$$

$${σ}^{2} = \frac{1}{batch} {\sum }_{i = 0}^{batch} {( {loss}_{i} - μ )}^{2} \qquad function ( 8 )$$

$${θ}^{t + 1} = {θ}^{t} - lr ∇ ( {loss}_{batch} ( {θ}^{t} ) ) \qquad function ( 9 )$$

In function (6), loss_{batch} is a training error set generated by a batch, μ is an average value of the error lossᵢ, σ² is a standard deviation of the error lossᵢ, θ is a parameter of the reweighting model 154, and θ⁺1 is a batching updating parameter.

The result of the loss function is used to adjust and update the parameters of the reweighting model 154, so the predicted temperature T_pred that is reconstructed by the model decoder 156 by using the predicted temperature feature ft_pred becomes as approximate the actual temperature of the training-sensing data as possible.

It should be noted that the training-sensing data of a training phase is the time curve, so the data processed in the training phase also corresponds to a feature curve.

In an embodiment, when using the loss function to perform the training process of the backpropagation algorithm, the computation device 112 filters the output value that is greater than a reasonable value from the output values of the loss function.

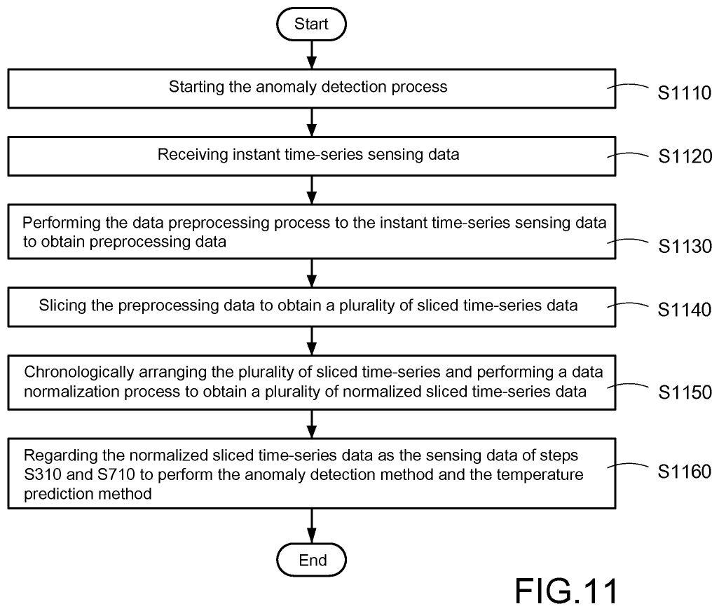

FIG. 11 is a flowchart illustrating the anomaly detection method by using a predicted temperature according to an embodiment of the present disclosure. The anomaly detection method of FIG. 11 may be performed by the computation device 112 of FIG. 2 or the temperature prediction device 600 of FIG. 6. For the sake of brevity, the following description takes the computation device 112 as an example of detecting an anomaly.

In step S1110, the computation device 112 starts the anomaly detection process.

In step S1120, the computation device 112 receives instant time-series sensing data.

In step S1130, the computation device 112 performs the data preprocessing process to the instant time-series sensing data to obtain preprocessing data.

In step S1140, the computation device 112 slices the preprocessing data to obtain a plurality of sliced time-series data.

In step S1150, the computation device 112 chronologically arranges the plurality of sliced time-series and performs a data normalization process to obtain a plurality of normalized sliced time-series data.

In step S1160, the computation device 112 regards the normalized sliced time-series data as the sensing data of steps S310 and S710 to perform the anomaly detection method and the temperature prediction method.

In step S1110, the computation device 112 loads the program codes for executing the anomaly detection process to perform the anomaly detection method by using the predicted temperature.

In step S1120, the computation device 112 keeps receiving the instant time-series sensing data. In an embodiment, the time-series sensing data received by the computation device 112 is a continuous time curve. The instant time-series sensing data may be received from the cloud database 142 (FIG. 1).

In step S1130, the data preprocessing process includes data cleaning, data type adjustment, data integration, and data transformation.

In step S1140, because the instant time-series sensing data received by the computation device 112 is the time curve, the computation device 112 slices the preprocessing data based on a time segment (such as 5 minutes) to reduce the size of curve data to the size of the time segment.

In step S1150, the sliced time-series data are arranged chronologically, and the computation device 112 performs the normalization process to the arranged sliced time-series data such that all the sliced time-series data is scaled to the same scale range.

In step S1160, the time-series sensing data are preprocessed, sliced, and normalized such that diversities among the original data are eliminated. Therefore, it is suitable to retrieve features from the normalized sliced time-series data. In the embodiment, the normalized sliced time-series data are regarded as the sensing data of steps S310 and S710, that is, the sensing data mentioned in steps S310 and S710 includes the data that is preprocessed, sliced, and normalized.

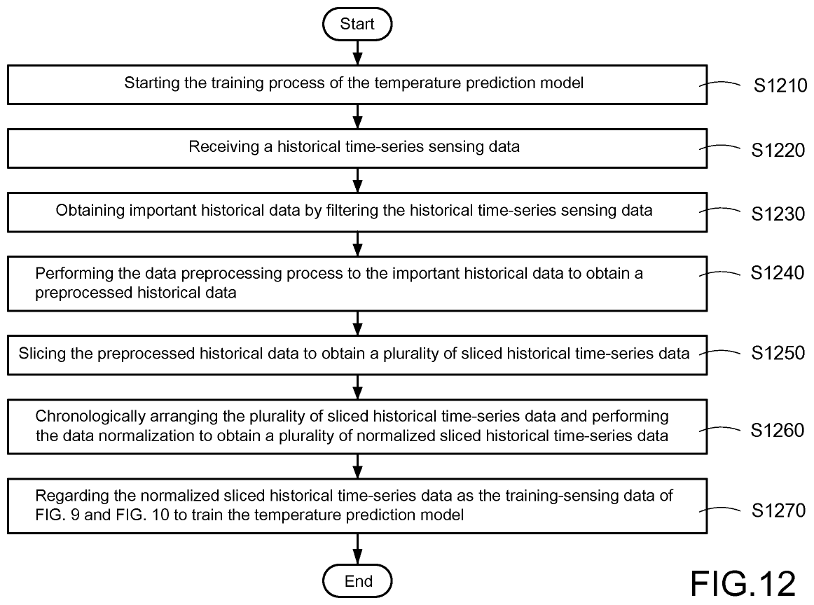

FIG. 12 is a flowchart illustrating a data preprocessing process of training the temperature prediction model according to an embodiment of the present disclosure. The data preprocessing process of training the temperature prediction model 150 may be performed by the computation device 112 of FIG. 2 or the temperature prediction device 600 of FIG. 6. For the sake of brevity, the following description takes the computation device 112 as an example of performing the data preprocessing process.

In step S1210, the computation device 112 starts the training process of the temperature prediction model 150.

In step S1220, the computation device 112 receives a historical time-series sensing data.

In step S1230, the computation device 112 obtains important historical data by filtering the historical time-series sensing data.

In step S1240, the computation device 112 performs the data preprocessing process to the important historical data to obtain a preprocessed historical data.

In step S1250, the computation device 112 slices the preprocessed historical data to obtain a plurality of sliced historical time-series data.

In step S1260, the computation device 112 chronologically arranges the plurality of sliced historical time-series data and performs the data normalization to obtain a plurality of normalized sliced historical time-series data.

In step S1270, the computation device 112 regards the normalized sliced historical time-series data as the training-sensing data of FIG. 9 and FIG. 10 to train the temperature prediction model 150.

In step S1210, the computation device 112 loads the program codes for executing the training process of the temperature prediction model 150.

In step S1220, the computation device 112 receives the historical time-series sensing data that have been generated before. For example, the historical time-series sensing data are the sensing data continuously received during the past year. In an embodiment, the historical time-series sensing data received by the computation device 112 is a continuous time curve. The historical time-series sensing data may be also received from the cloud database 142 (FIG. 1) in another embodiment.

In step S1240, the computation device 112 retrieves the sensing data related to the temperature from the historical time-series sensing data.

Steps S1250 to S1260 are similar to steps S1130 to S1150 and not repeated for brevity.

In step S1270, the historical time-series sensing data are preprocessed, sliced, and normalized such that diversities among the original historical data are eliminated. Therefore, it is suitable to retrieve features from the normalized sliced historical time-series data and use the normalized sliced historical time-series data for training the temperature prediction model 150. In the embodiment, the normalized sliced historical time-series data is regarded as the training-sensing data of FIG. 9 and FIG. 10, that is, the training-sensing data mentioned in FIG. 9 and FIG. 10 is the data preprocessed, sliced, and normalized.

In an embodiment, the computation device 112 randomly samples a batch data in each unit of time (e.g., the time segment) from the normalized sliced historical time-series data to obtain a plurality of random batch data and performs data augmentation by using the plurality of random batch data, so the efficiency of training the temperature prediction model 150 is improved.

In an embodiment, the computation device 112 and the temperature prediction device 600 may be devices disposed on cloud, and the devices that perform the steps of the methods of the present disclosure are not limited to local or cloud sites.

Accordingly, the anomaly detection method for the energy storage system, the power control system, and the temperature prediction device provided in the present disclosure precisely predict the temperature of the electronic components by the model encoders, the reweighting model, and the model decoder, and compare the predicted temperature with the current temperature to determine whether the energy storage system operates normally. The maintenance staff may be well-prepared in advance before the devices malfunction or electric power goes off, that is, take countermeasures before the electronic system crashes. Therefore, the problem that the entire system crashes due to some electronic components being damaged is solved, and the technical effects that the entire system being stable and the power supply remaining uninterrupted are achieved.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An anomaly detection method for an energy storage system, comprising steps of:
(a) receiving a plurality of sensing data retrieved from an electronic component of the energy storage system, wherein each of the plurality of sensing data is respectively related to one type:
(b) respectively inputting the plurality of sensing data to a temperature prediction model according to the type of each of the plurality of sensing data, wherein the temperature prediction model comprises a plurality of model encoders, a reweighting model, and a model decoder:
(c) receiving, by each of the plurality of model encoders, the plurality of sensing data of same type and respectively computing a plurality of time-series features related to the type based on the plurality of sensing data of the type:
(d) outputting the plurality of time-series features of each type to the reweighting model:
(e) computing, by the reweighting model, a predicted temperature feature by using the plurality of time-series features and outputting the predicted temperature feature to the model decoder:
(f) reconstructing, by the model decoder, the predicted temperature feature to generate a predicted temperature of the electronic component; and
(g) determining whether the electronic component operates abnormally by estimating an error between the predicted temperature and a current temperature.

2. The anomaly detection method according to claim 1, wherein step (e) further comprises steps of:
respectively receiving, by a plurality of first layers of the reweighting model, the plurality of time-series features and computing a first relation feature by each of the plurality of first layers:
receiving, by a second layer of the reweighting model, the first relation feature from each of the plurality of first layers and computing a relationship between the first relation feature of each first layer and the first relation features of other first layers to generate a second relation feature; and
receiving, by a concatenate layer of the reweighting model, the second relation features from the second layer and computing the predicted temperature feature.

3. The anomaly detection method according to claim 1, wherein some of the plurality of time-series features received by the model decoder are related to a power module temperature, and step (f) further comprises a step of:
computing, by the model decoder, the predicted temperature feature by using the plurality of time-series features and the time-series feature of the power module temperature and reconstructing, by the model decoder, the predicted temperature feature by referring to the time-series features related to the power module temperature.

4. The anomaly detection method according to claim 1, wherein step (g) further comprises steps of:
adding an abnormal count when the error is greater than a threshold; and
determining that the electronic component operates abnormally when the abnormal count is accumulated to be greater than a tolerance value during a detection period.

5. The anomaly detection method according to claim 1, comprising training the temperature prediction model before performing step (b), and comprising steps of:
respectively training a plurality of autoencoders according to a plurality of training-sensing data, wherein each of the plurality of autoencoders comprises a training-encoder and a training-decoder and each of the plurality of autoencoders is respectively related to one of the types:
determining that each of the plurality of autoencoders is well-trained when a difference value between a training-reconstruction data of each of the plurality of autoencoders and each of the plurality of the training-sensing data inputted is less than a training threshold; and
setting the plurality of training-encoders to be the plurality of model encoders.

6. The anomaly detection method according to claim 5, comprising training the reweighting model before performing step (d), and comprising steps of:
computing a training error by using a loss function:
determining whether to adopt the plurality of training-sensing data according to the training error; and
implementing a backpropagation algorithm by using the plurality of training-sensing data being adopted to update parameters of the reweighting model.

7. The anomaly detection method according to claim 1, wherein the type of each of the plurality of sensing data comprises a power module temperature, a liquid-cooling system temperature, and an electric power system value.

8. The anomaly detection method according to claim 1, wherein each of the plurality of the sensing data is related to a time curve of the type.

9. A power control system, comprising:
a sensor module, configured to retrieve a plurality of sensing data of an electronic component, wherein each of the plurality of sensing data is respectively related to one type:
a storage medium, connected to the sensor module and configured to store a temperature prediction model, wherein the temperature prediction model comprises:
a plurality of model encoders, configured to receive the plurality of sensing data:
a reweighting model, connected to the plurality of model encoders; and
a model decoder, connected to the reweighting model; and
a computation device, connected to the sensor module and the storage medium and configured to perform operations by using the temperature prediction model, comprising steps of:
receiving, by each of the plurality of model encoders, the plurality of sensing data of same type and respectively computing a plurality of time-series features related to the type by using the plurality of sensing data of same type:
outputting the plurality of time-series features of each type to the reweighting model:
computing, by the reweighting model, a predicted temperature feature based on the plurality of time-series features and outputting the predicted temperature feature to the model decoder:
reconstructing, by the model decoder, the predicted temperature feature to generate a predicted temperature of the electronic component; and
determining whether the electronic component operates abnormally by estimating an error between the predicted temperature and a current temperature.

10. The power control system according to claim 9, wherein the computation device is configured to perform steps of:
respectively receiving, by a plurality of first layers of the reweighting model, the plurality of time-series features and computing a first relation feature by each of the plurality of first layers:
receiving, by a second layer of the reweighting model, the first relation feature from each of the plurality of first layers and computing a relationship between the first relation feature of each first layer and the first relation features of other first layers to generate a plurality of second relation features; and
receiving, by a concatenate layer of the reweighting model, the plurality of second relation features from the second layer to compute the predicted temperature feature.

11. The power control system according to claim 9, wherein some of the plurality of time-series features received by the model decoder are related to a power module temperature, and the computation device is configured to perform a step of:
computing, by the model decoder, the predicted temperature feature by using the plurality of time-series features and the time-series features that are related to the power module temperature and reconstructing, by the model decoder, the predicted temperature feature by referring to the time-series feature that are related to the power module temperature.

12. The power control system according to claim 9, wherein the computation device is configured to perform steps of:
adding an abnormal count when the error is greater than a threshold; and
determining that the electronic component operates abnormally when the abnormal count is accumulated to be greater than a tolerance value during a detection period.

13. The power control system according to claim 9, wherein the computation device is configured to perform steps of:
respectively training a plurality of autoencoders according to a plurality of training-sensing data, wherein each of the plurality of autoencoders comprises a training-encoder and a training-decoder and each of the plurality of autoencoders is respectively related to one of the types:
determining that each of the plurality of autoencoders is well-trained when a difference value between a training-reconstruction data of each of the plurality of autoencoders and each of the plurality of the training-sensing data inputted is less than a training threshold; and
setting the plurality of training-encoders to be the plurality of model encoders.

14. The power control system according to claim 13, wherein the computation device is configured to perform steps of:
computing a training error by using a loss function:
determining whether to adopt the plurality of training-sensing data according to the training error; and
implementing a backpropagation algorithm by using the plurality of training-sensing data being adopted to update parameters of the reweighting model.

15. The power control system according to claim 9, wherein the type of each of the plurality of sensing data comprises a power module temperature, a liquid-cooling system temperature, and an electric power system value.

16. A temperature prediction device, comprising:
a storage medium, configured to store program codes; and
a processor, connected to the storage medium and configured to load the program codes to perform operations comprising steps of:
receiving a plurality of sensing data retrieved from an electronic component of an energy storage system, wherein each of the plurality of sensing data is respectively related to one type;
respectively inputting the plurality of sensing data to a temperature prediction model according to the type of each of the plurality of sensing data, wherein the temperature prediction model comprises a plurality of model encoders, a reweighting model, and a model decoder;
receiving, by each of the plurality of model encoders, the plurality of sensing data of same type and respectively computing a plurality of time-series features related to the type based on the plurality of sensing data of same type;
outputting the plurality of time-series features of each type to the reweighting model;
computing, by the reweighting model, a predicted temperature feature by using the plurality of time-series features and outputting the predicted temperature feature to the model decoder; and
reconstructing, by the model decoder, the predicted temperature feature to generate a predicted temperature of the electronic component.
